(19) United States
(12) Patent Application Publication
(10) Pub. No.: US 2018/0348016 A1
(43) Pub. Date: Dec. 6, 2018

(54) ENCODER AND BEARING UNIT COMPRISING AN ENCODER

(71) Applicant: Schaeffler Technologies AG & Co. KG, Herzogenaurach (DE)

(72) Inventors: Florian Koeniger, Schweinfurt (DE); Christian Mock, Schweinfurt (DE)

(73) Assignee: Schaeffler Technologies AG & Co. KG, Herzogenaurach (DE)

(21) Appl. No.: 15/775,611

(22) PCT Filed: Oct. 26, 2016
(86) PCT No.: PCT/DE2016/200491

§ 371 Date: May 11, 2018

(30) Foreign Application Priority Data
Nov. 26, 2015 (DE) 10 2015 223 418.5

(51) Int. Cl. G01D 5/245

(52) U.S. Cl. CPC G01D 5/2454

(57) ABSTRACT

Encoders for bearing units are disclosed. In one example, an encoder includes a magnet part connected to a support part. The magnet part may have a U-shaped cross section formed by a plurality of magnets, wherein the plurality of magnets are situated in alternation with alternating magnetizations. An approximately homogeneous magnetic field may form in a cavity formed by the U-shaped cross section. A signal amplitude of the magnetization along an encoder circumference (U) and within the cavity may be nearly independent of a position of a magnetic-field-measuring sensor.

### CROSS-REFERENCE TO RELATED APPLICATIONS

This application is the U.S. National Phase of PCT Appln. No. PCT/DE2016/200491 filed Oct. 26, 2016, which claims priority to DE 102015223418.5 filed Nov. 26, 2015, the entire disclosures of which are incorporated by reference herein.

### TECHNICAL FIELD

The disclosure relates to an encoder. The application further relates to a bearing unit comprising an encoder.

### BACKGROUND

Encoders have been known from the prior art for a long time. Magnetic encoders and magnetic-field-measuring sensors are utilized for the contactless detection of relative motions between stationary and movable machine parts. The encoder comprises a magnetic component which is provided, along the direction of motion, with one or multiple alternating magnetizations, e.g., north-south pole. The magnetic-field-measuring sensor detects this polarity reversal and converts it into an electrical signal which is useful for a computer-assisted further processing step. In order to increase the resolution of the system, e.g., to generate more increments per displacement and/or rotational angle, one can either magnetize more magnetic poles on the encoder or change the signal evaluation.

The number of pole pairs can be increased, although this simultaneously results in a loss of signal strength due to the smaller pole surface, and therefore the magnetic-field-measuring sensor can no longer reliably detect the magnetic field of the encoder, which results in a faulty speed detection. This loss of signal strength can be only partially compensated for by a more highly magnetizable material of the magnet part.

Various possibilities exist for increasing the resolution of the signal evaluation. A first possibility is described in U.S. Pat. No. 7,825,653 B2, wherein a sensor contains a unit which generates a pulse sequence. It is disadvantageous that a large time offset results between the sensor output and the encoder movement, since the pulse sequence must first be generated in a chip.

Yet another possibility is described in U.S. Pat. No. 7,923,993 B2, wherein a use of multiple magnetic tracks and multiple measuring elements takes place. Since multiple tracks having an exact angular offset are necessary, production is time-consuming and expensive.

### SUMMARY

The technical problem to be solved is therefore that of overcoming the disadvantages from the prior art. Therefore, an encoder should also be provided, in the case of which a magnetic field is largely independent of the position or positional fluctuations resulting from component tolerances of the encoder and the sensor.

The problem may be solved according to the disclosure, in particular, by an encoder for bearing units, comprising a magnet part connected to a support part, wherein the magnet part has a U-shaped cross section formed by a plurality of magnets, wherein the magnets are situated in alternation with alternating magnetizations, and wherein an approximately homogeneous magnetic field forms in a cavity formed by the U-shaped cross section and a signal amplitude of the magnetization along the encoder circumference and within the cavity is nearly independent of the position of a magnetic-field-measuring sensor.

Due to the provision of the encoder, the amplitude of the resultant sinusoidal magnetic field in a sensor is largely independent of its position or positional fluctuations resulting from component tolerances.

The magnet part is preferably designed to be annular. The poles of the magnets of the magnet part are situated in such a way that a positive pole (north pole) of one magnet always abuts a negative pole (south pole) of another magnet, and vice versa. Preferably, an approximately homogeneous magnetic field forms in a cavity formed by a U-shaped cross section.

The approximately constant amplitude of the sinusoidal magnetic field is to be preferably utilized for the subsequent signal processing in the sensor, in order to adjust the number of switching thresholds for converting the magnetic field into a digital signal (electrical current or voltage). Therefore, more pulses can be output from the system for the same number of pole pairs.

Preferably, a proven material which is comparable to the prior art for the magnet part is utilized for the U-shaped cross section according to the disclosure, which has the effect of reducing costs.

Preferably, remaining fluctuations in the signal can be compensated for by way of correspondingly adaptively updated switching thresholds in the chip.

In one embodiment, the encoder is an encoder ring.

The cavity is preferably an open space. Due to the provision of the U-shaped cross section, the approximately homogeneous magnetic field can be easily generated in the cavity which is delimited by the U-shaped cross section of the magnets.

The magnets may have the shape of horseshoe magnets. A shape for the magnets is therefore selected, which can be produced in a simple and inexpensive way.

In one embodiment according to the disclosure, the magnets comprise a first portion having a first L-shaped cross section and a second portion having a second L-shaped cross section, wherein the two portions are differently magnetized.

Preferably, an axis of rotation of the encoder is parallel to one of the legs of the support part. The orientation of the U-shaped cross section therefore extends either in an axial direction or in a radial direction.

In yet another embodiment according to the disclosure, the magnet part is composed of a compound consisting of a support matrix and a magnetic filler, wherein a support matrix is composed of an elastomer, a thermoplastic polymer, or a thermosetting plastic, and wherein the magnetic filler contains hard ferrite, iron, rare earth, or a combination thereof.

Preferably, a connection of the magnet part to the support part can take place by means of adhesive/cohesive methods with the use of a binding agent (primer) or a binding agent system (primer and cover). In addition, it can be provided that the magnet part mechanically engages around the support part.

In yet another embodiment according to the disclosure, the magnet part rests against one side of the support part in a planar manner.

Therefore, the magnets or the entire magnet part can be easily fixed on the support part in a planar manner.

Furthermore, the problem is solved according to the disclosure, in particular, by a bearing unit comprising a sensor and an encoder, as described above, wherein the sensor is situated in the cavity formed by the U-shaped cross section.

Due to the provision of the U-shaped cross section, the approximately homogeneous magnetic field can be easily generated in the cavity which is delimited by the U-shaped cross section of the magnets.

The bearing unit is preferably formed as a wheel bearing for commercial vehicles, trucks, passenger cars, etc.

In one embodiment according to the disclosure, the conversion of the magnetic field into an electrical signal is based on the principle of the magnetoresistive effect, the Hall effect, the use of field plates, the magnetoelastic effect, or the use of saturated core magnetometers.

Preferably, the magnetic signal strength (flux density or field strength) which can be detected by way of the sensor is constant, from a technical perspective, within a tolerated position range. A saturated core magnetometer, which is also referred to as a fluxgate magnetometer or colloquially in German speaking countries as a Foerster probe, after the name of the inventor, is used for vectorially determining the magnetic field.

This yields a resultant greater minimum signal. This signal can be utilized in a downstream signal processing step, in order to detect movement of the encoder, in that further switching levels, e.g., not only the zero crossing, are introduced.

In yet another embodiment according to the disclosure, the signal evaluation in the sensor utilizes not only the zero crossing but also further and, therefore, multiple switching thresholds, in order to increase the resultant resolution of the output pulses for a speed detection.

In yet another embodiment according to the disclosure, the sensor comprises multiple magnetic-field-measuring elements, wherein the sensor is designed for detecting not only the detection of a speed of rotation but also a direction of rotation.

### BRIEF DESCRIPTION OF THE DRAWINGS

The disclosure will now be described by way of example with reference to figures. Therein:

FIG. 1 shows a schematic view of a known encoder comprising a sensor,

FIG. 2 shows a section A-A through the encoder from FIG. 1,

FIG. 3 shows a schematic representation of magnetic field lines around the circumference of the encoder from FIG. 1,

FIG. 4 shows a signal strength-distance graph with respect to FIG. 2,

FIG. 5 shows a schematic view of an encoder according to the disclosure, comprising a sensor,

FIG. 6 shows a section B-B through the encoder from FIG. 5,

FIG. 7 shows a schematic representation of the magnetic field lines with respect to FIG. 6,

FIG. 8 shows a distance-signal strength graph with respect to FIG. 6,

FIG. 9 shows a graph for illustrating the signal evaluation in the case of a known bearing unit, and

FIG. 10 shows a graph for illustrating the signal evaluation in the case of the bearing unit according to the disclosure.

### DETAILED DESCRIPTION

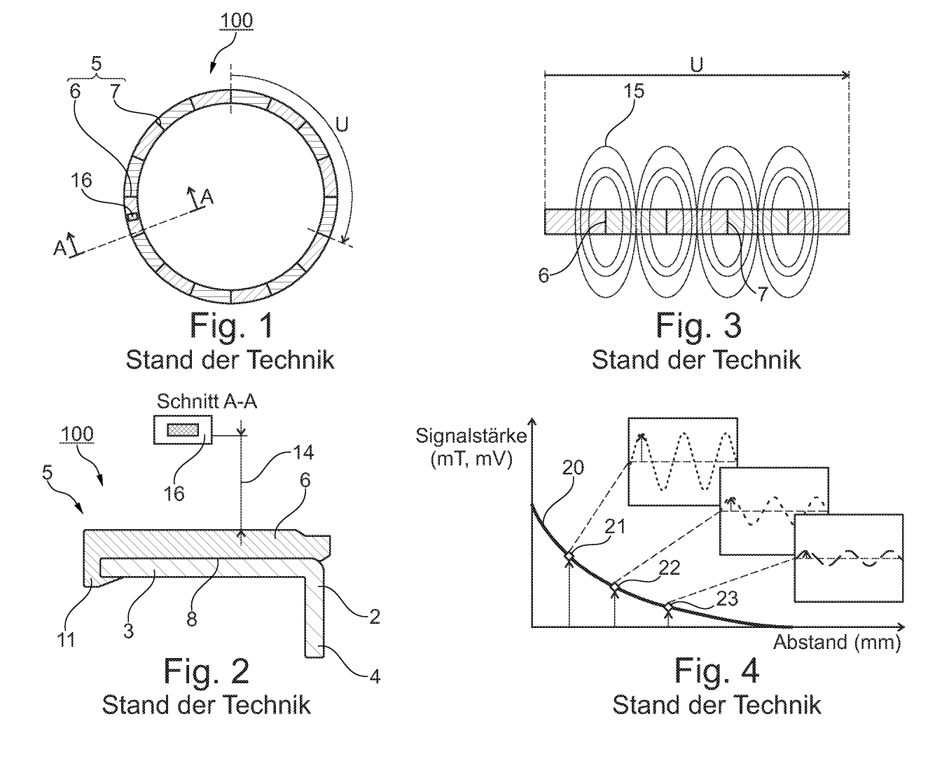

FIG. 1 shows the schematic view of a known encoder 100 comprising a sensor 16. The encoder 100 is installed in a bearing unit (not shown). The encoder 100 comprises a magnet part 5 connected to a support part 2. The magnet part 5 has a plurality of differently magnetized areas. The areas are designed as segments which are situated next to each other and have alternating magnetizations, wherein two areas form magnets 6, 7 in each case, which, in totality, form the magnet part 5.

As shown in section A-A according to FIG. 2, the magnets 6, 7 have an approximately rectangular cross section. A sensor 16 is situated at a distance 14 from the surface of the magnet 6 or the magnet part 5.

FIG. 3 shows the schematic representation of magnetic field lines around the circumference of the encoder from FIG. 1 along a circumferential portion U.

FIG. 4 shows the distance-signal strength graph with respect to FIG. 2. The distance 14 of the sensor to a magnet is plotted on the x-axis. A signal strength/amplitude of the encoder magnetic field detected by the sensor is plotted on the y-axis. The smaller images show the associated signal curves during rotation of the encoder; the magnetic signals have a sinusoidal shape along the circumference. The particular amplitudes are labeled with the points 21, 22, 23 in the distance-signal strength graph. The line 20 shown follows a function which is defined by the points 21, 22, 23. The signal strength is dependent on a distance 14 (according to FIG. 2) of the sensor 16 to the magnet part 5 of the encoder 1. That is, the further away the sensor 16 is from the magnet part 5, the lesser the signal strength is.

In technical applications, the resultant distance 14 is subject to very great tolerance influences. A resultant minimum signal is therefore correspondingly low. Therefore, only a reversal of the magnetic polarity (polarity reversal), e.g., the zero crossing in the signal, can be utilized for detecting the movement. Intermediate stages in the signal cannot be reliably evaluated, since the range of variation in the signal intensity is too great.

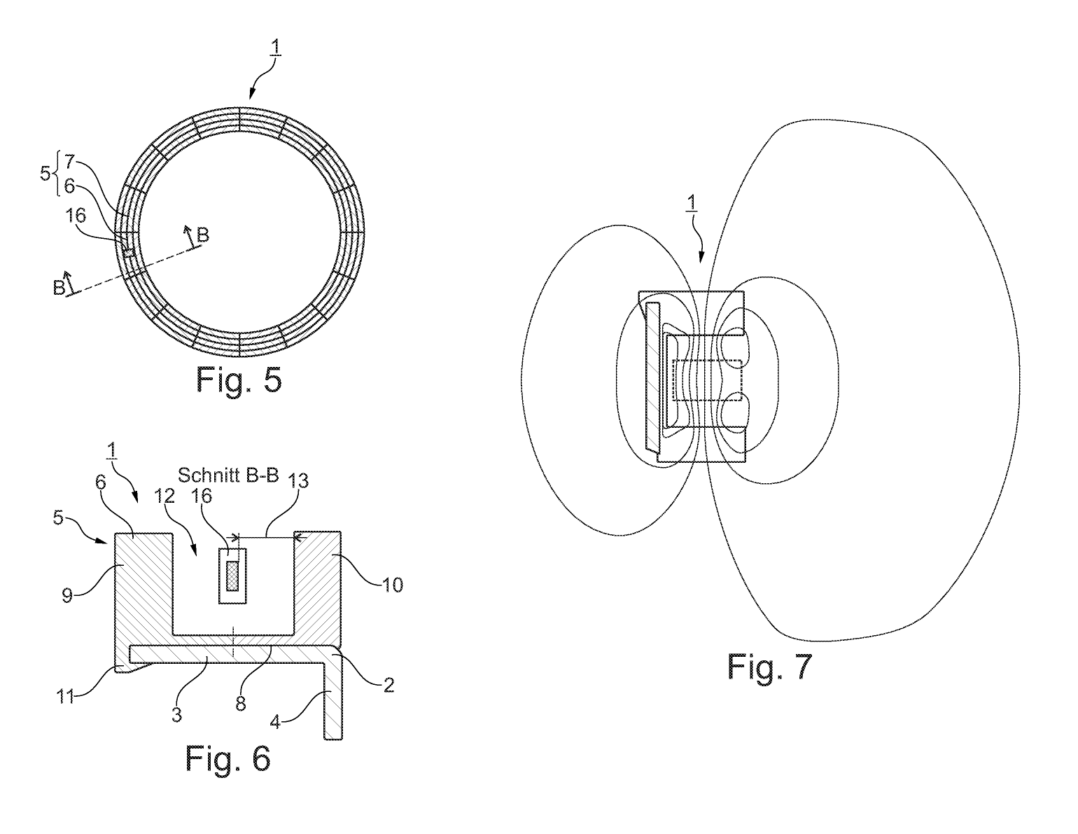

FIG. 5 shows the schematic view of an encoder 1 according to the disclosure, comprising a sensor 16. The encoder 1 is installed in a bearing unit (not shown). The encoder 1 comprises a magnet part 5 connected to a support part 2. The magnet part 5 comprises a plurality of magnets 6, 7. The magnets 6, 7 are situated annularly, one behind the other, with alternating magnetizations and form the magnet part 5. The magnet part 5 is designed to be annular in this case. The poles of the magnets 6, 7 of the magnet part 5 are situated in such a way that a positive pole of one magnet 6 always abuts a negative pole of another magnet 7, and vice versa.

As shown in section B-B according to FIG. 6, the magnets 6, 7 have a U-shaped cross section. The magnets 6, 7 are designed as horseshoe magnets. The magnets 6, 7 comprise a first portion 9 having a first L-shaped cross section and a second portion 10 having a second L-shaped cross section. The two portions 9, 10 are differently magnetized. The support part 2 comprises a first leg 3 and a second leg 4. One leg of each of the two portions 9, 10 rests against the leg 3 of the support part 2 in a planar manner. In this case, a contact surface 8 is formed between the leg 3 of the support part 2 and the legs of the two portions 9, 10. A sensor 16 is situated within the U-shaped cross section at a distance 13 from the surface of the magnet 6 or the magnet part 5.

FIG. 7 shows a schematic representation of the magnetic field lines with respect to FIG. 6. An approximately homogeneous magnetic field 15 is formed in a cavity 12 formed by the U-shaped cross section. Due to the provision of the U-shaped cross section, an approximately homogeneous magnetic field can be easily generated in the cavity 12 which is formed by the U-shaped cross section of the magnets 6, 7.

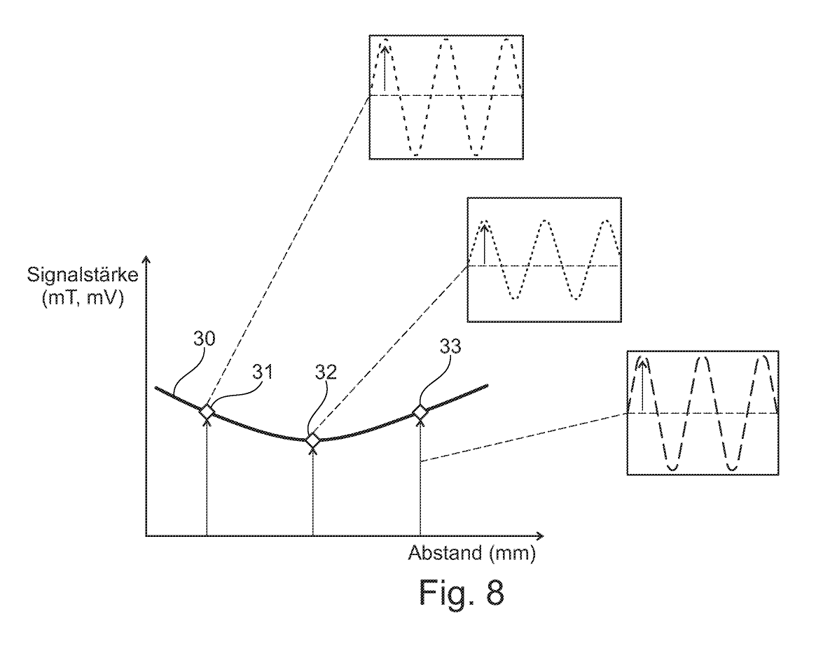

FIG. 8 shows the distance-signal strength graph with respect to FIG. 6. The distance 13 (according to FIG. 6) of the sensor to a magnet is plotted on the x-axis. A signal strength of the sensor is plotted on the y-axis. The line 30 shown follows a function which is defined by the points 31, 32, 33. The signal strength is nearly independent of a distance 13 (according to FIG. 6) of the sensor 16 to the magnet part 5 of the encoder 1.

This yields a resultant greater minimum signal. This signal can be utilized in a downstream signal processing step, in order to detect movement of the encoder, in that further switching levels, e.g., not only the zero crossing, are introduced.

A conversion of the magnetic field into an electrical signal is based on the principle of the magnetoresistive effect, the Hall effect, the use of field plates, the magnetoelastic effect, or the use of saturated core magnetometers (Foerster probe/fluxgate).

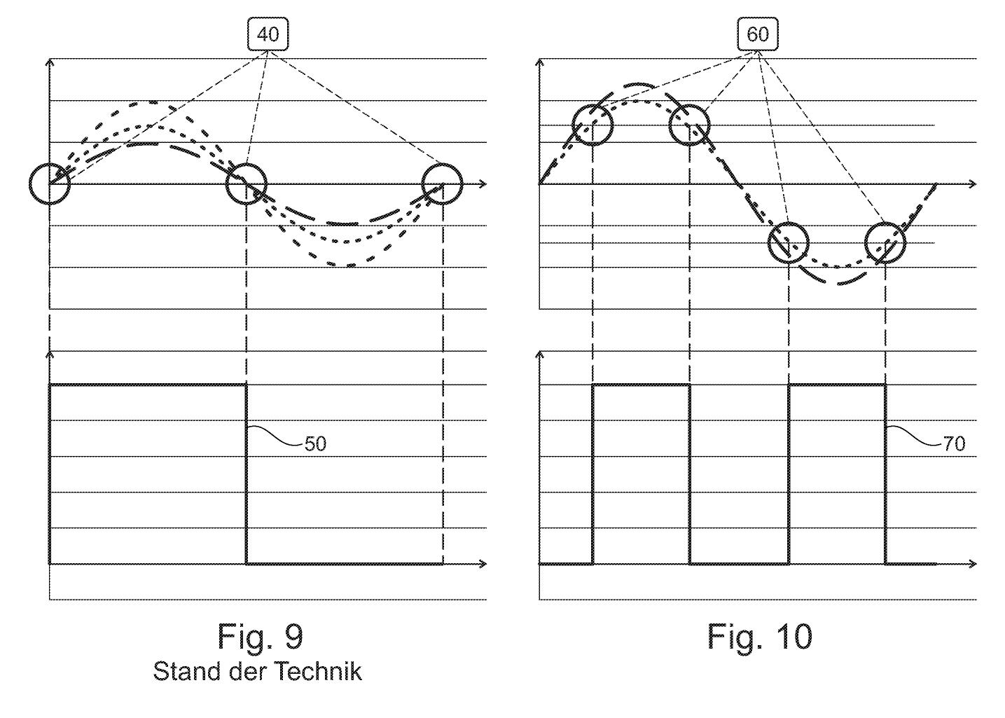

FIG. 9 shows the graph for illustrating the signal evaluation in the case of a known bearing unit. Strong fluctuations of the signal strength (magnetic field) are apparent. A reliable switching is possible only at the zero crossing 40. Resulting therefrom is a digital output signal having one pulse sequence 50 per pole pair.

FIG. 10 shows a graph for illustrating the signal evaluation in the case of the bearing unit according to the disclosure. Lesser fluctuations of the signal strength (magnetic field) are apparent. A reliable switching is possible not only at the zero crossing, but also at other levels 60. Resulting therefrom is a digital output signal having two pulse sequences 70 per pole pair.

### LIST OF REFERENCE SIGNS

1 encoder

2 support part

3 leg

4 leg

5 magnet part

6 magnet

7 magnet

8 base

9 portion

10 portion

11 snap hook

12 cavity

13 distance

14 distance

15 magnetic field

16 sensor

20 line

21 point

22 point

23 point

30 line

31 point

32 point

33 point

40 zero crossing

50 pulse sequence

60 level

70 pulse sequence

100 encoder

U circumference

1. An encoder for bearing units, comprising:
a magnet part connected to a support part;
the magnet part having a U-shaped cross section formed by a plurality of magnets, wherein the plurality of magnets are situated in alternation with alternating magnetizations;
wherein an approximately homogeneous magnetic field forms in a cavity formed by the U-shaped cross section; and
wherein a signal amplitude of the magnetization along an encoder circumference (U) and within the cavity is nearly independent of a position of a magnetic-field-measuring sensor.

2. The encoder as claimed in claim 1, wherein the magnets comprise a first portion having a first L-shaped cross section and a second portion having a second L-shaped cross section, and wherein the first and second portions are differently magnetized.

3. The encoder as claimed in claim 1, wherein the magnet part is composed of a compound consisting of a support matrix and a magnetic filler, wherein the support matrix is composed of an elastomer, a thermoplastic polymer, or a thermosetting plastic, and wherein the magnetic filler contains hard ferrite, iron, rare earth, or a combination thereof.

4. The encoder as claimed in claim 1, wherein the magnet part rests against a leg of the support part in a planar manner.

5. A bearing unit comprising a sensor and an encoder as claimed in claim 1, wherein the sensor is situated in the cavity formed by the U-shaped cross section.

6. The bearing unit as claimed in claim 5, wherein a conversion of the magnetic field into an electrical signal is based on the principle of the magnetoresistive effect, the Hall effect, the use of field plates, the magnetoelastic effect, or the use of saturated core magnetometers.

7. The bearing unit as claimed in claim 5, wherein a signal evaluation in the sensor utilizes not only a zero crossing but also multiple switching thresholds, in order to increase a resultant resolution of output pulses for a speed detection.

8. The bearing unit as claimed in claim 5, wherein the sensor comprises multiple magnetic-field-measuring elements, wherein the sensor is designed for detecting not only a speed of rotation but also a direction of rotation.
